(19) United States
(12) Patent Application Publication
(10) Pub. No.: US 2022/0277213 A1
(43) Pub. Date: Sep. 1, 2022

(54) HORIZON-AWARE CUMULATIVE ACCESSIBILITY ESTIMATION

(71) Applicant: The Toronto-Dominion Bank, Toronto (CA)

(72) Inventors: Harry Joseph Braviner, Toronto (CA); Panteha Naderian, Toronto (CA); Gabriel Loaiza-Ganem, Toronto (CA)

(21) Appl. No.: 17/485,837

(22) Filed: Sep. 27, 2021

Related U.S. Application Data
(60) Provisional application No. 63/155,233, filed on Mar. 1, 2021.

(51) Int. Cl. G06N 7/00; H04L 29/08

(52) U.S. Cl. CPC G06N 7/005; H04L 67/12

(57) ABSTRACT

A cumulative accessibility estimation (CAE) system estimates the probability that an agent will reach a goal state within a time horizon to determine which actions the agent should take. The CAE system receives agent data from an agent and estimates the probability that the agent will reach a goal state within a time horizon based on the agent data. The CAE system may use a CAE model that is trained to estimate a cumulative accessibility function to estimate the probability that the agent will reach the goal state within the time horizon. The CAE system may use the CAE model to identify an optimal action for the agent based on the agent data. The CAE system may then transmit the optimal action to the agent for the agent to perform.

### CROSS REFERENCE TO RELATED APPLICATION

The present disclosure claims the benefit of U.S. Provisional Patent Application No. 63/155,233, entitled “C-Learning: Horizon-Aware Cumulative Accessibility Estimation” and filed on Mar. 1, 2021, which is hereby incorporated by reference.

### BACKGROUND

Reinforcement learning is a process of training machine learning models in an uncertain environment with delayed rewards. Reinforcement learning can involve providing instructions to an agent within the environment to achieve optimal outcomes while also learning more about the environment. Where reinforcement learning models are used to solve goal-reaching problems, an agent is attempting to get from a starting state to a goal state. For example, if the agent is an autonomous vehicle, the start state may be where the vehicle picks up a passenger, the goal state may be the passenger's intended destination, and the reinforcement learning model may be determining actions for the vehicle to take to travel from the start state to the goal state.

Conventionally, reinforcement learning models solving goal-reaching problems may use Q-learning algorithms to determine the optimal action to take in a particular state. Generally, Q-learning determines an optimal action to take in a particular state by summing, for each possible action the agent can take, the immediate value the agent will accumulate by taking the action with a discounted expected value the agent will achieve by taking optimal actions for all future actions. In other words,

$$Q ( {s}_{t} , {a}_{t} ) = R ( {s}_{t} , {a}_{t} ) + γ * {max}_{a ∈ A} ( Q ( {s}_{t + 1} , a ) ) ,$$

where Q is the function that determines the value of taking a particular action while in a particular state, R is the reward function that determines the reward received by the agent by taking a particular action in a particular state, A is a discount factor, and A is the set of all actions that an agent can take.

However, Q-learning has some significant limitations when used in goal-reaching contexts. Q-learning is generally unable to find multiple paths to reach the goal state, and thus is unable to balance the relative risks and rewards of different paths. Additionally, in complex environments, Q-learning requires the agent to interact with the environment a significant number of times before the Q-learning model can give effective results.

### SUMMARY

A cumulative accessibility estimation (CAE) system estimates the probability that an agent will reach a goal state within a time horizon to determine which actions the agent should take. The CAE system receives agent data from an agent. The agent data describes the present state that the agent is in and may additionally include one or more actions that the agent can take while in the agent's present state.

The CAE system estimates the probability that the agent will reach a goal state within a time horizon based on the agent data. The goal state is an intended state for the agent to reach, and the time horizon is an amount of time within which the agent must reach the goal state. The CAE system may use a CAE model that is trained to estimate a cumulative accessibility function to estimate the probability that the agent will reach the goal state within the time horizon. The CAE model may comprise neural networks that are trained to estimate the cumulative accessibility function. The CAE model may be trained based on a CAE characteristic. In some embodiments, the CAE characteristic is a recursive relationship possessed by a cumulative accessibility function, such as a modified version of the Bellman equation. To train the CAE model, the CAE characteristic may be used as the basis for a loss function.

The CAE system may use the CAE model to identify an optimal action for the agent based on the agent data. The optimal action for the agent may be the action the agent should take with the highest probability of reaching the goal state within the time horizon, as determined by the CAE model. The CAE system may then transmit the optimal action to the agent for the agent to perform.

A CAE system improves on conventional reinforcement learning techniques by reducing the number of times an agent needs to gather information about an environment for the CAE system to be accurate in its action selection. Additionally, by modifying the time horizon, a CAE system allows for improved balancing of the risks of more speedily reaching the goal state with the possibility of not reaching the goal state in time.

### BRIEF DESCRIPTION OF THE DRAWINGS

FIG. 1 illustrates an example system environment and architecture for a CAE system, in accordance with some embodiments.

FIG. 2 illustrates how an agent may use a CAE system to reach a goal state, in accordance with some embodiments.

FIG. 3 is a flowchart for a method for applying a CAE model, in accordance with some embodiments.

FIG. 4 is a flowchart for a method of training a CAE model, in accordance with some embodiments.

### DETAILED DESCRIPTION

### Example System Environment and Architecture

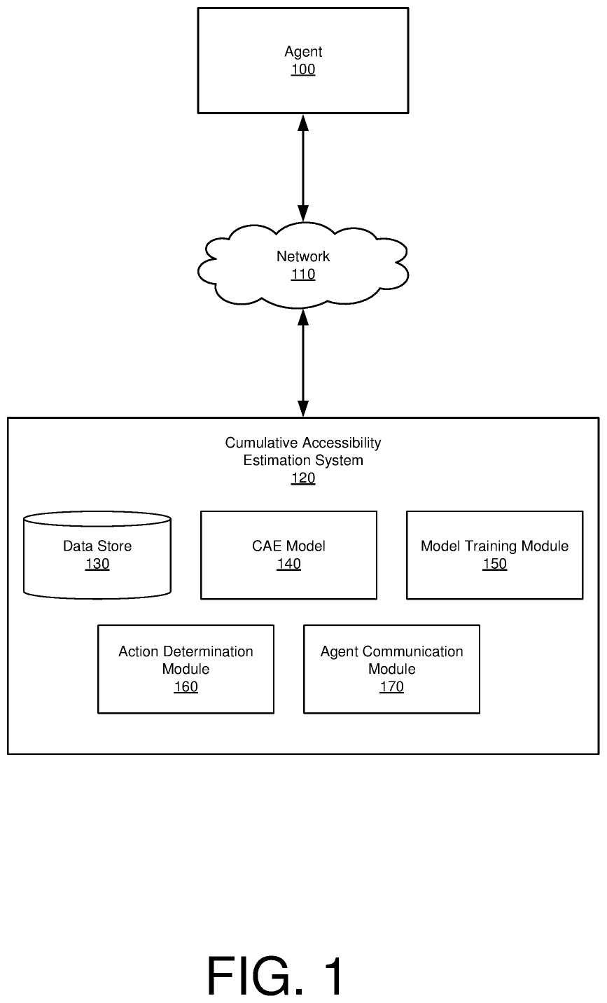

FIG. 1 illustrates an example system environment for a CAE system 120, in accordance with some embodiments. The system environment illustrated in FIG. 1 includes an agent 100, a network 110, and a CAE system 120. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

The agent 100 is an entity that executes the actions selected by the CAE system 120. The agent 100 includes components that allow the agent 100 to perform whatever actions the CAE system 120 selects. Since the CAE system 120 may be used in a broad variety of contexts, the agent 100 may include a broad variety of components required to act within those contexts. The agent 100 may include hardware components to execute actions. For example, the agent 100 may include components that allow the agent 100 to move (e.g., an engine, wheels, steering system) or components that allow the agent 100 to manipulate objects (e.g., a robotic arm). Additionally, the agent 100 may include software components to execute actions. For example, the agent 100 may include software that operates a car, generates a web page, interprets speech, purchases securities, or performs any other action that the agent 100 would need to perform. The agent 100 may also include a data store and a processor for storing and executing software. In some embodiments, the agent 100 is a general-purpose computing device, such as a personal computer, a laptop, a tablet, or a smartphone.

The agent 100 operates within an environment and may include components that allow the agent 100 to collect information about the environment. For example, the agent 100 may include sensors or meters that measure the agent's environment. Additionally, the agent 100 may include components that collect information about the state the agent 100 is in and the action that the agent 100 has taken, is taking, or will take. In some embodiments, the agent 100 includes additional hardware or software components for communicating with the CAE system 120, such as a network card, a Bluetooth chip, or a wireless broadband card.

In some embodiments, the agent 100 is part of the CAE system 120, and thus communicates directly with the CAE system 120. Alternatively, the agent 100 may communicate with CAE system 120 via a network 110. The network 110 may comprise any combination of local area and wide area networks employing wired or wireless communication links. In some embodiments, the network 110 uses standard communications technologies and protocols. For example, the network 110 includes communication links using technologies such as Ethernet, 802.11, worldwide interoperability for microwave access (WiMAX), 4G, 5G, code division multiple access (CDMA), digital subscriber line (DSL), etc. Examples of networking protocols used for communicating via the network 110 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 110 may be represented using any format, such as hypertext markup language (HTML) or extensible markup language (XML). In some embodiments, all or some of the communication links of the network 110 may be encrypted.

FIG. 1 also illustrates an example system architecture of a CAE system 120, in accordance with some embodiments. The CAE system 120 illustrated in FIG. 1 includes a data store 130, a CAE model 140, a model training module 150, an agent communication module 160 and an action determination module 170. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

The data store 130 stores data used by the CAE system 120 to train the CAE model 140 and to determine actions for the agent 100 to perform. The data store 130 may receive and store agent data from the agent 100. Agent data is data about the agent's state and the potential actions the agent 100 may take. The agent's state is the situation the agent 100 is in within an environment. The potential actions of an agent 100 are the potential operations the agent 100 can take to transition from one state to another. For example, where an agent 100 is operating in an urban city environment as an autonomous vehicle, the agent's state may be the agent's location within the urban city environment, and the potential actions of the agent 100 may be driving operations (e.g., turn steering wheel, accelerate, brake) that the agent 100 can take as an autonomous vehicle. In some embodiments, the data store 130 stores the agent's state space (i.e., the set of all possible states the agent 100 can be in) or the agent's action space (i.e., the set of all possible actions the agent 100 can take in any state). Furthermore, the data store 130 may store information about the agent's past states and past actions.

In some embodiments, the data store 130 stores information about the agent's environment that the agent 100 has captured. For example, if the agent 100 includes sensor components that capture sensor information about the agent's surroundings, then the captured sensor information may be transmitted by the agent 100 to the CAE system 120 and stored in the data store 130. Additionally, the data store 130 may store a goal state for the agent 100 to reach. The goal state for the agent 100 is the intended state for the agent 100 to reach. Furthermore, the data store 130 may store a time horizon for the agent 100. A time horizon is parameter used by the CAE model 140 that dictates an amount of time within which the agent 100 must reach the goal state. How the time horizon is used by the CAE model 140 is described in more detail below.

The CAE model 140 is a machine-learning model that estimates the probability that the agent 100 will reach a goal state within a time horizon. Specifically, the CAE model 140 models a cumulative accessibility function, or C*, defined as:

$${C}^{*} ( s , a , g , h ) = ℙ {max}_{t = 0 , … , h} ( G ( {s}_{t} , g ) = 1 \vert s = {s}_{0} , a = {a}_{0} ) ,$$

where s is a state of the agent 100, a is an action the agent 100 may take, g is the goal state of the agent 100, and h is the time horizon. As used herein, C* is a function that outputs the true probability that the agent 100 will reach goal state g from state s within time horizon h by taking action a. Furthermore, C is the CAE model's approximation of C.

In some embodiments, the CAE model 140 is a neural network that is trained by the model training module 150 to estimate C*. For example, the CAE model 140 may include a linear model, a tabular model, or an artificial neural network, such as a fully connected network, a recurrent neural network, or an attention network. Additionally, the CAE model 140 may include a table of probability values that are updated as the agent 100 interacts with its environment. For example, the table may store probabilities of reaching the goal state for each state and possible action at each state. The table may be updated as the agent 100 gathers more information about the probabilities of transitioning from one state to another state by taking a particular action.

The model training module 150 updates the CAE model 140 such that the CAE model, over time, better approximates C*. The model training module 150 updates the CAE model 140 based on a CAE characteristic. A CAE characteristic is a characteristic that C* has that can be used to determine how closely C approximates C. In some embodiments, the CAE characteristic used by the model training module 150 is a recursive relationship of C* before and after the agent 100 takes an action. For example, the recursive CAE characteristic may be a modified version of the Bellman equation. Specifically, C* may have the following recursive CAE characteristic:

$${C}^{*} ( s , a , g , h ) = \{ \begin{matrix}{𝔼}_{{s}^{′} ∼ p ( \cdot \vert s , a )} [ {max}_{a ∈ A} {C}^{*} ( {s}^{′} , {a}^{′} , g , h - 1 ) ] & if G ( s , g ) = 0 and h \geq 1 \\ G ( s , g ) & otherwise\end{matrix} .$$

In other words, C* for some initial state s and some considered action a is dependent on C* for the subsequent state that the agent 100 reaches after taking the action a. The model training module 150 assumes that the agent 100 will take optimal actions, according to C*, for all future actions to reach the goal state. Thus, the model training module 150 determines the maximum C* for each potential subsequent state s′ that the agent 100 may reach by taking action a, and then calculates the expected value of those C* values based on the probability that the agent 100 will reach each subsequent state s′. If the agent 100 is at the goal state and the time horizon has not ended, then C* is 100%. Similarly, if the agent 100 has not reached the goal state within the time horizon, then the C* is 0%.

In some embodiments, the goal-attainment function, G (s, g), is 1 if s=g and 0 if s≠g. Alternatively, the goal-attainment function may be 1 if s is sufficiently close to g. In some embodiments, the goal-attainment function may deem s to be sufficiently close to g if only a subset of elements of s match g. As an example, if the agent 100 is an autonomous vehicle, and s comprises an x-coordinate, a y-coordinate, and an orientation, the goal-attainment function may deem s to be sufficiently close to g where only the x- and y-coordinates of s match g. Additionally, the goal-attainment function may be 1 if elements of s are within some threshold difference of corresponding elements of g. For example, the goal-attainment function may find that g and s are sufficiently close if the x-coordinate, y-coordinate, and orientation of s are sufficiently close to the x-coordinate, y-coordinate, and orientation of g.

In embodiments where the CAE model 140 includes a neural network, the model training module 150 may use a loss function based on the CAE characteristic for the training of the neural network. The loss function may be based on the extent to which C complies with the CAE characteristic, thereby determining the extent to which C accurately estimates C*. For example, if the model training module 150 uses the recursive CAE characteristic described above, then the loss function may be based on the difference between C for some initial state s and action a, and the expected value of C for subsequent states and actions of the agent 100 as described above regarding the recursive CAE characteristic. Specifically, the loss function may be based on ΔC, where:

$$Δ C = C ( s , a , g , h ) - {𝔼}_{{s}^{′} ∼ p ( \cdot \vert s , a )} [ {max}_{a ∈ A} {C}^{*} ( {s}^{′} , {a}^{′} , g , h - 1 ) ] .$$

Note that as C more accurately reflects C*, the value of ΔC approaches 0, given the recursive CAE characteristic above that C* has. In some embodiments, the loss function is based on the square or the absolute value of ΔC.

The action determination module 160 applies the CAE model 140 to agent data received from the agent 100 and selects an action for the agent 100 to perform. In some embodiments, the action determination module 160 determines a current state of the agent 100 based on information received from that agent 100 and identifies an optimal action for the agent 100 to take in the current state based on value of C for each possible action the agent 100 may take at that state. In some embodiments, the action determination module 160 determines a state of the agent 100 based on data collected by sensors or meters by the agent 100.

In some embodiments, the action determination module 160 determines that the agent 100 should perform a random action rather than a determined optimal action. The action determination module 160 may select some proportion of overall actions to be random actions and may select the actions randomly or on some set interval. In some embodiments, the action determination module 160 may change the rate at which it selects random actions for the agent 100 based on the CAE characteristic. For example, if C differs significantly from C* such that C is regularly or significantly out of compliance with the CAE characteristic, then the action determination module 160 may increase the rate at which it selects a random action. This can allow the CAE model 140 to be trained based on states or environment information that the CAE model 140 may not have seen. In some embodiments, the rate at which the action determination module 160 selects random actions is increased or decreased based on the value of a loss function.

The agent communication module 170 receives information from the agent 100 and transmits information to the agent 100. The agent communication module 170 may receive data from the agent 100 describing the agent's state or the environment in which the agent 100 is operating, and store the data in the data store 130. Additionally, the agent communication module 170 may transmit to the agent 100 actions selected by the action determination module 160 for the agent 100 to perform. The agent communication module 170 may transmit a single action to the agent 100 or may transmit multiple actions at once. The agent communication module 170 may receive information from the agent 100 and transmit information to the agent 100 via the network 110.

### Example Agent Using CAE System

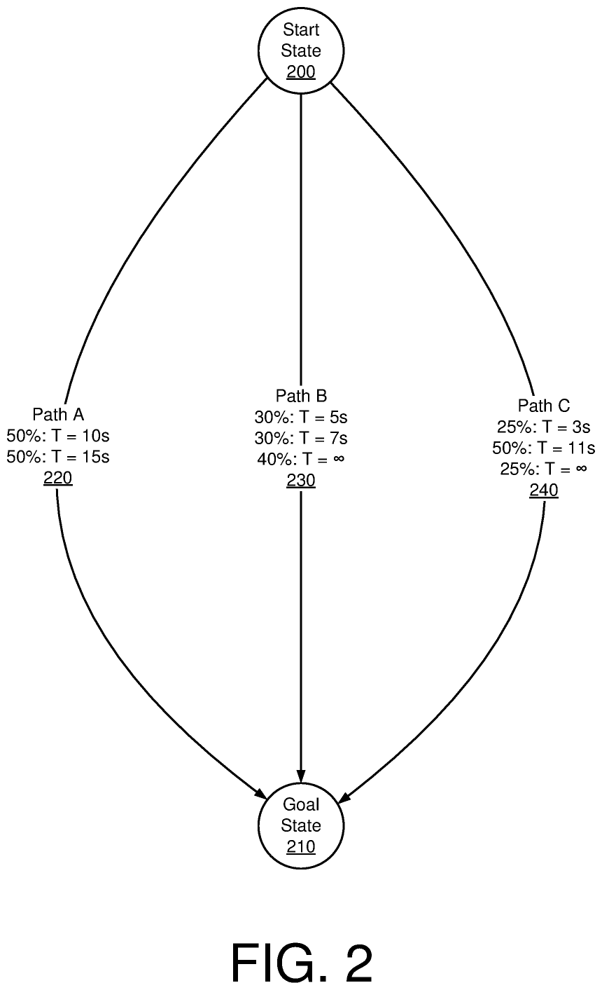

FIG. 2 illustrates how an agent may use a CAE system to reach a goal state, in accordance with some embodiments. While the embodiment illustrated in FIG. 2 shows three paths that go directly from the start state 200 to the goal state 210, alternative embodiments may include more or fewer paths with one or more intermediate states between the start state 200 and the goal state 210. Additionally, while FIG. 2 represents the uncertainty in selecting paths as being based on the time it might take to get from start state 200 to goal state 210, uncertainty in how long it will take the agent to reach the goal state may additionally or alternatively stem from uncertainty in which state the agent will transition to by taking a particular action or uncertainty about the states through which the agent needs to transition to eventually reach the goal state. FIG. 2 is intended only to serve as an illustration of an example embodiment, not to limit the scope of this disclosure.

In FIG. 2, the agent starts at the start state 200 and intends to reach the goal state 210. From the start state 200, there are three paths that the agent may take to reach the goal state 210. Path A 220 has a 50% chance of taking 10 seconds and a 50% chance of taking 15 seconds. Path B 230 has a 30% chance of taking 5 seconds, a 30% chance of taking 7 seconds, and a 40% chance of not reaching the goal state (i.e., taking an infinite number of seconds to reach the goal state). Path C 240 has a 25% chance of taking 3 seconds, a 50% chance of taking 11 seconds, and a 25% chance of not reaching the goal state.

In the embodiment illustrated in FIG. 2, the action for the agent to take is to pick a path and to take that path to the goal state 210. To determine which path the agent should take, the CAE system determines which path has the highest likelihood of reaching the goal state 210 within the time horizon. Thus, the path that the CAE system selects depends on the time horizon. If the time horizon is 15 seconds, the CAE system would select Path A 220, because that path is the only path of the three that has a 100% chance of reaching the goal state 210 within 15 seconds. Similarly, if the time horizon were 10 seconds, the CAE system would select Path B 230, since Path B has a 60% chance of reaching the goal state 210 within 10 seconds, as compared to 50% and 25% for Path A 220 and Path C respectively. Finally, if the time horizon is 4 seconds, the CAE system would pick Path C 240, because it would be impossible to reach the goal state 210 within the time horizon using either of the other two paths.

### Example Application and Training of CAE Model

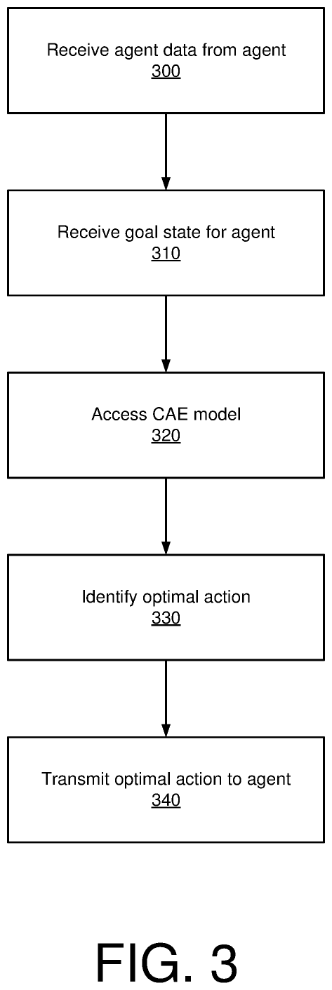

FIG. 3 is a flowchart for a method of using a CAE model, in accordance with some embodiments. Alternative embodiments may include more, fewer, or different steps from those illustrated in FIG. 3, and the steps may be performed in a different order from that illustrated in FIG. 3. Additionally, each of these steps may be performed automatically by the CAE system without human intervention.

The CAE system receives 300 agent data from an agent. The agent data describes a present state of the agent and one or more actions that the agent can perform in the present state of the agent. In some embodiments, the agent data contains information captured by the agent about the agent's environment, and the CAE system determines the agent's present state based on the captured information. The CAE system also receives 310 a goal state for the agent. The goal state is an intended state for the agent to reach.

The CAE system accesses 320 a CAE model that estimates the probability that the agent will reach the goal state within a time horizon. The time horizon is an amount of time within which the agent must reach the goal state. The time horizon may be a time interval or may be a maximum number of actions the agent may take before reaching the goal state.

In some embodiments, the CAE model is a neural network that estimates a cumulative accessibility function. The CAE model is trained based on a CAE characteristic. The CAE characteristic is a characteristic that the CAE model possesses if the CAE model accurately models the cumulative accessibility function. In some embodiments, the CAE characteristic is a recursive relationship that the cumulative accessibility function possesses. For example, the CAE characteristic may be based on a modified version of the Bellman equation. The modified Bellman equation may indicate that the CAE model's estimation of a cumulative accessibility function at an initial state and initial action should be a function of the expected value of the estimated cumulative accessibility function at potential subsequent states using potential subsequent actions. The modified Bellman equation may assume the agent will take optimal actions to reach the goal state at each subsequent state.

The CAE system identifies 330 an optimal action of the one or more actions that the agent can perform in the agent's present state. The optimal action may be identified by the CAE model as being the action the agent should take with the highest probability of reaching the goal state within the time horizon. The CAE system transmits 340 the optimal action to the agent for the agent to perform.

In some embodiments, after transmitting 340 the optimal action to the agent to perform, the CAE system receives additional agent data from the agent after the agent performs the action. The CAE system may then update the CAE model based on the additional agent data.

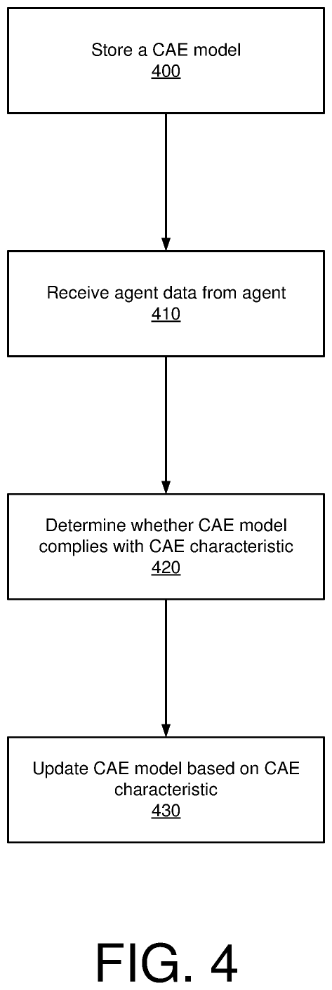

FIG. 4 is a flowchart for a method of training a CAE model, in accordance with some embodiments. Alternative embodiments may include more, fewer, or different steps from those illustrated in FIG. 4, and the steps may be performed in a different order from that illustrated in FIG. 4. Additionally, each of these steps may be performed automatically by the CAE system without human intervention. Furthermore, the steps in FIG. 4 may be performed before, during, or after the steps in FIG. 3.

The CAE system stores 400 a CAE model. The CAE model estimates the probability that an agent will reach the goal state within a time horizon. The goal state is an intended state for the agent to reach. The time horizon is an amount of time within which the agent must reach the goal state. The time horizon may be a time interval or may be a maximum number of actions the agent may take before reaching the goal state.

The CAE system receives 410 agent data from the agent. The agent data describes a present state of the agent and one or more actions that the agent can perform in the present state of the agent. In some embodiments, the agent data contains information captured by the agent about the agent's environment, and the CAE system determines the agent's present state based on the captured information.

The CAE system determines 420 whether the CAE model complies with a CAE characteristic based on the agent data. The CAE characteristic is a characteristic that the CAE model possesses if the CAE model accurately models the cumulative accessibility function. In some embodiments, the CAE characteristic is a recursive relationship that the cumulative accessibility function possesses. For example, the CAE characteristic may be based on a modified version of the Bellman equation.

The CAE system updates 430 the CAE model based on the CAE characteristic. The CAE system may only update 430 the CAE model if the CAE model does not comply with the CAE characteristic. In some embodiments, the CAE system uses a loss function based on the CAE characteristic to update a neural network of the CAE model. The loss function may be based on the difference between the value of the CAE model's estimation of a cumulative accessibility function for some initial state and action, and the expected value of the estimation of the cumulative accessibility function for subsequent states and actions. The loss function may perform some additional calculations on this difference, e.g., by squaring or taking the absolute value of the difference. The CAE system may then apply the CAE model to further agent data after updating the CAE model.

### Additional Considerations

The foregoing description of the embodiments has been presented for the purpose of illustration; it is not intended to be exhaustive or to limit the patent rights to the precise pages disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some embodiments, a software module is implemented with a computer program product comprising one or more computer-readable media containing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition A or B is satisfied by any one of the following: A is true (or present) and B is false (or not present), A is false (or not present) and B is true (or present), and both A and B are true (or present).

What is claimed is:

1. A system for using a cumulative accessibility estimation (CAE) model comprising:
a processor; and
one or more non-transitory, computer readable media comprising instructions that, when executed by the processor, cause the processor to:
receive agent data from an agent, wherein the agent data describes a present state of the agent and one or more actions that the agent can perform in the present state of the agent;
receive a goal state for the agent, wherein the goal state is an intended state for the agent to reach;
access a CAE model, wherein the CAE model estimates a probability that the agent will reach the goal state within a time horizon, and wherein the CAE model is trained based on a CAE characteristic;
identify an optimal action of the one or more actions, wherein the optimal action is identified based on the CAE model, and wherein the optimal action is an action for the agent to perform with a highest probability of reaching the goal state within the time horizon; and
transmit, to the agent, the optimal action for the agent to perform.

2. The system of claim 1, wherein the agent data contains information about an environment of the agent and wherein the present state of the agent is determined based on the information about the environment of the agent.

3. The system of claim 2, wherein the information about the environment of the agent comprises sensor data or meter data captured by the agent.

4. The system of claim 1, wherein the CAE model comprises a neural network.

5. The system of claim 1, wherein the CAE model estimates a cumulative accessibility function.

6. The system of claim 5, wherein the CAE characteristic is a characteristic of the cumulative accessibility function.

7. The system of claim 6, wherein the CAE characteristic based on a recursive relationship of the cumulative accessibility function.

8. The system of claim 7, wherein the CAE characteristic is based on a modified version of the Bellman equation.

9. The system of claim 1, wherein the computer readable media further comprise instructions that cause the processor to update the CAE model based on the agent data and the CAE characteristic.

10. The system of claim 9, wherein updating the CAE model based on the agent data comprises determining a difference between a value of the CAE model's estimation of a cumulative accessibility function for the present state of the agent and an action of the one or more actions.

11. A method for using a cumulative accessibility estimation (CAE) model comprising:
receiving agent data from an agent, wherein the agent data describes a present state of the agent and one or more actions that the agent can perform in the present state of the agent;
receiving a goal state for the agent, wherein the goal state is an intended state for the agent to reach;
accessing a CAE model, wherein the CAE model estimates a probability that the agent will reach the goal state within a time horizon, and wherein the CAE model is trained based on a CAE characteristic;
identifying an optimal action of the one or more actions, wherein the optimal action is identified based on the CAE model, and wherein the optimal action is an action for the agent to perform with a highest probability of reaching the goal state within the time horizon; and
transmitting, to the agent, the optimal action for the agent to perform.

12. The method of claim 11, wherein the agent data contains information about an environment of the agent and wherein the present state of the agent is determined based on the information about the environment of the agent.

13. The method of claim 12, wherein the information about the environment of the agent comprises sensor data or meter data captured by the agent.

14. The method of claim 11, wherein the CAE model comprises a neural network.

15. The method of claim 11, wherein the CAE model estimates a cumulative accessibility function.

16. The method of claim 15, wherein the CAE characteristic is a characteristic of the cumulative accessibility function.

17. The method of claim 16, wherein the CAE characteristic based on a recursive relationship of the cumulative accessibility function.

18. The method of claim 17, wherein the CAE characteristic is based on a modified version of the Bellman equation.

19. The method of claim 11, further comprising updating the CAE model based on the agent data and the CAE characteristic.

20. The method of claim 19, wherein updating the CAE model based on the agent data comprises determining a difference between a value of the CAE model's estimation of a cumulative accessibility function for the present state of the agent and an action of the one or more actions.
